(19) United States
(12) Patent Application Publication
(10) Pub. No.: US 2026/0109004 A1
(43) Pub. Date: Apr. 23, 2026

(54) MODULAR TRAY SYSTEM

(71) Applicant: New Revo Brand Group, LLC, Maple Grove, MN (US)

(72) Inventors: Mike Feesl, Inver Grove Heights, MN (US); Howard Tripp, Plymouth, MN (US); Ryan Jacobson, Andover, MN (US)

(21) Appl. No.: 19/423,204

(22) Filed: Dec. 17, 2025

Related U.S. Application Data
(63) Continuation-in-part of application No. 18/536,476, filed on Dec. 12, 2023, now Pat. No. 12,560,400.
Application No. 18/536,476 is a continuation-in-part of application No. 29/917,566, filed on Nov. 21, 2023.
Application No. 29/917,566 is a continuation of application No. 29/869,240, filed on Dec. 27, 2022, now Pat. No. D1080371.
Application No. 18/536,476 is a continuation of application No. 18/152,247, filed on Jan. 10, 2023, now Pat. No. 11,933,569.
Application No. 18/152,247 is a continuation-in-part of application No. 18/489,450, filed on Oct. 18, 2023.
Application No. 18/489,450 is a continuation of application No. 18/152,247, filed on Jan. 10, 2023, now Pat. No. 11,933,569.

(51) Int. Cl. B25B 1/24; A47B 43/00; A47B 81/00; A47F 7/00; B25B 1/02; B25B 1/10; B25B 1/22; B25B 5/00; B25B 5/06; B60R 7/14; F16C 11/10; F16M 11/14; F16M 13/02; F41A 23/18

(52) U.S. Cl. CPC B25B 1/2405; A47B 43/00; A47B 81/005; A47F 7/0035; B25B 1/02; B25B 1/10; B25B 1/22; B60R 7/14; F16M 11/14; F41A 23/18; B25B 5/006; B25B 5/068; F16C 11/106; F16M 13/022; F16M 2200/022

(57) ABSTRACT

A modular tray system can include a tray assembly and a ball head joint. The tray assembly can have a main tray and at least one liner tray nested in an interior of the main tray. The ball head joint can have a ball head and a stem, wherein the stem connects to the tray assembly. The modular tray system can include at least one magnet located between the main tray and the at least one liner tray. The at least one liner tray can have a plurality of compartments, wherein at least one magnet is located underneath each of the plurality of compartments. The at least one liner tray can be comprised of a first liner tray having a single compartment and a second liner have multiple compartments. A cover can secure onto the tray assembly to retain any pieces/liquids stored in the at least one liner tray.

### FIELD OF THE INVENTION

This disclosure relates to a modular tray system, and more particularly, relates to a tray system having a tray assembly, a cover, and a ball head joint for connection of the tray system to a ball head connector.

### BACKGROUND OF THE INVENTION

During maintenance or construction activities, various small parts are often removed from, or needed for assembly of, a device and require transient, secure storage. Additionally, during construction and assembly, liquids such as, but not limited to, paints, glues, solvents, etc. are frequently used and may need safe, reliable places to be put down or kept while in use. Currently, there exist few solutions to address these situations and, therefore, it is desirable to provide a tray system that can accommodate transient, secure storage of assembly components, fasteners, and/or liquids.

### SUMMARY OF THE INVENTION

This disclosure relates to a modular tray system, and more particularly, relates to a tray system having a tray assembly, a cover, and a ball head joint for connection of the tray system to a ball head connector. In an illustrative but non-limiting example, the disclosure provides a modular tray system comprising a tray assembly and a ball head joint. The tray assembly can have a main tray, and at least one liner tray nested in an interior of the main tray. The ball head joint can have a ball head and a stem, wherein the stem can connect to the tray assembly.

In some cases, the modular tray system can further include at least one magnet. The at least one magnet may be an array of magnets, and the array of magnets may be located between the main tray and the at least one liner tray. In some cases, the main tray may have a rectangular profile, a solid base and four solid walls, and the array of magnets can include four magnets, one near each corner. And in some cases, the at least one liner tray may have a plurality of compartments, and at least one magnet from the array of magnets may be located underneath each of the plurality of compartments.

In some cases, the at least one liner tray can comprise a first liner tray and a second liner tray. The second liner tray may have a plurality of compartments. Further, the modular tray system may include a cover having a plurality of compartments that correspond to the compartments of the second liner tray. Additionally, the cover may be securely attachable to the tray assembly, and the second liner and the cover can create an airtight seal. In some cases, the second liner tray may be removable. The second liner tray may also be comprised of a flexible material, which may be silicone. In some cases, the modular tray system may further include an array of magnets evenly distributed between the main tray and the first liner tray. Further, the first liner tray may be permanently affixed to the main tray, the second liner tray may be a removable, flexible liner tray, and the stem of the ball head joint may be affixed to the main tray.

In some cases, the modular tray system may include a cover, and the cover and the tray assembly may attach to each other to create an airtight seal. The cover may be transiently affixed to the tray assembly. Further, the cover may have a snap fit engagement with the main tray.

In some cases, the ball head joint can connect to a side of the tray assembly such that a longitudinal axis of the stem is parallel to a bottom plane of the main tray. And in some cases, the ball head joint can be threadedly engaged with the tray assembly. In some cases, the at least one liner tray can be comprised of a continuous, solid material.

In another illustrative but non-limiting example, the disclosure provides a modular tray system comprising a tray assembly, at least one magnet, and a connection apparatus connected to the tray assembly. The tray assembly can include a main tray, a first liner tray nested in an interior of the main tray, and a second liner tray nested in an interior of the first liner tray. The at least one magnet can be located between the main tray and the first liner tray. In some cases, the connection apparatus can enable the tray assembly to be suspended in space. For example, the connection apparatus can be a gooseneck, and the tray assembly can connect to the gooseneck.

The above summary is not intended to describe each and every example or every implementation of the disclosure. The Description that follows more particularly exemplifies various illustrative embodiments.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 is a top perspective view of a modular tray system.

FIG. 2 is a front view of the modular tray system.

FIG. 3 is left side view of the modular tray system; the right side view of the modular tray system is a mirror image.

FIG. 4 is a rear view of the modular tray system.

FIG. 5 is a top view of the modular tray system.

FIG. 6 is a bottom view of the modular tray system.

FIG. 7 is a top, perspective exploded view of the modular tray system.

FIG. 8 is a bottom, perspective exploded view of the modular tray system.

FIG. 9 is a top, perspective view of modular tray system connected to a double ball joint connector.

FIG. 10 is a front, perspective view of modular tray system connected to a double ball joint connector that is connected to a connection device.

FIG. 11 is a cross-sectional view of the modular tray system connected to taken from line 11-11 in FIG. 5.

FIG. 12 is a cross-sectional view of the modular tray system connected to taken from line 12-12 in FIG. 5.

### DETAILED DESCRIPTION

This disclosure relates to a modular tray system, and more particularly, relates to a tray system having a tray assembly, a cover, and a ball head joint for connection of the tray system to a ball head connector. Various embodiments are described in detail with reference to the drawings, in which like reference numerals may be used to represent like parts and assemblies throughout the several views. Reference to various embodiments does not limit the scope of the systems and methods disclosed herein. Examples of construction, dimensions, and materials may be illustrated for the various elements, those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

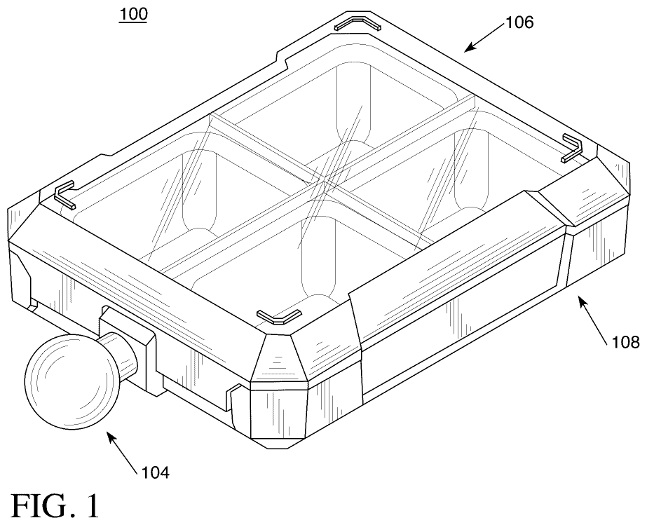

The present disclosure describes a modular tray system that can aid users in transiently organizing and securing small pieces, components, fasteners, or liquids. FIGS. 1-12 illustrate the tray assembly, cover, and ball head joint of the modular tray system.

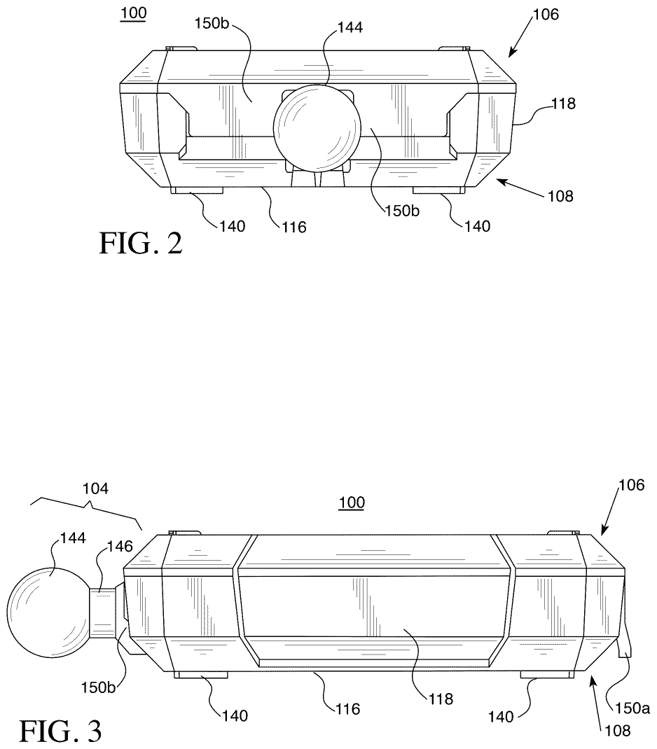

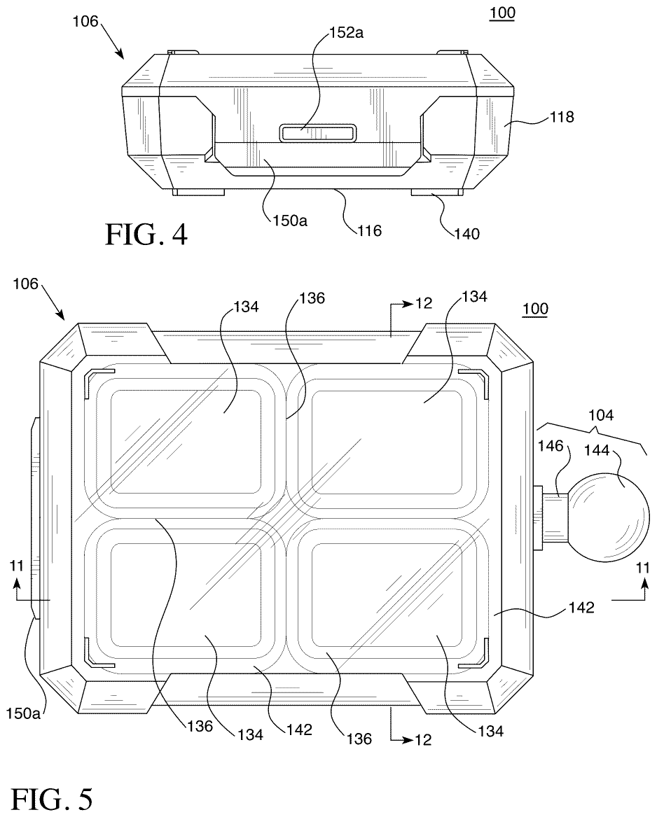

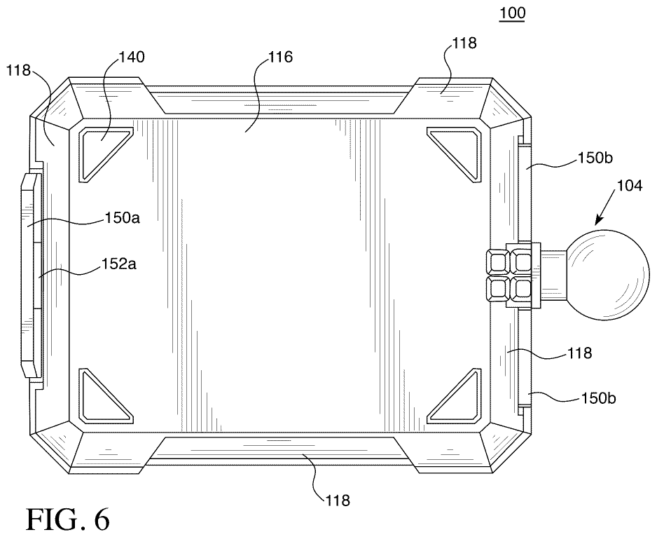

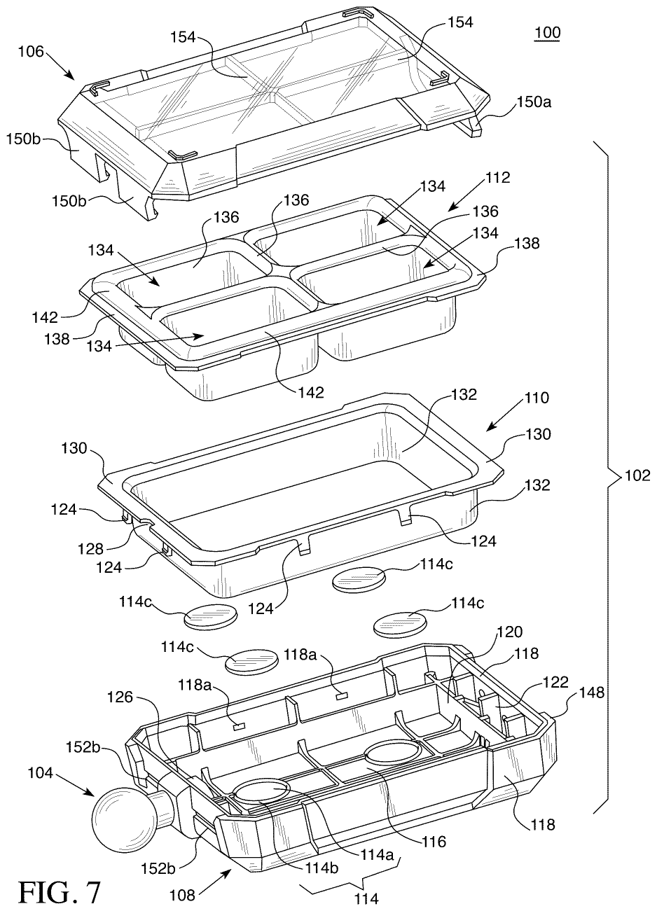

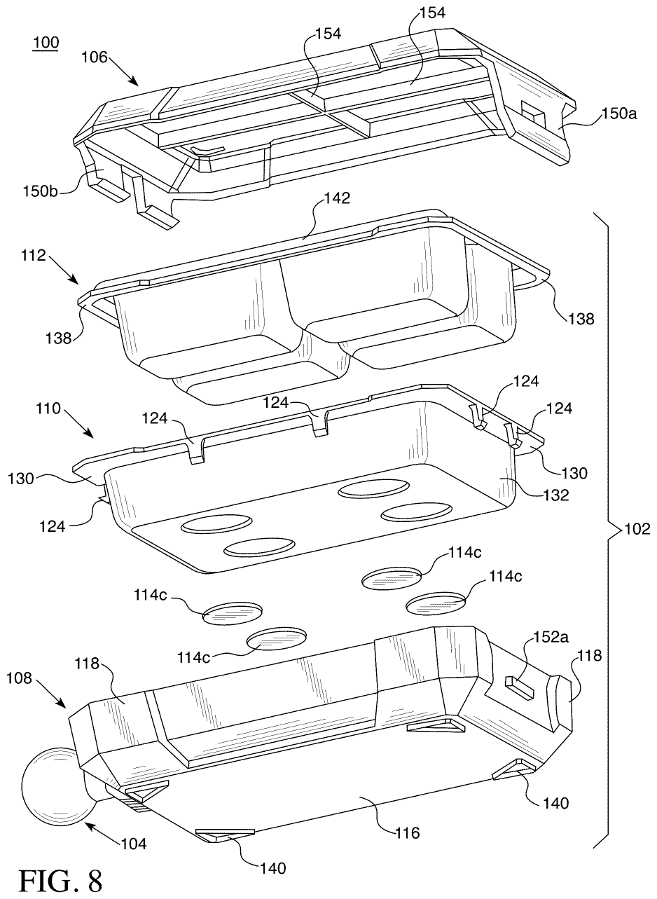

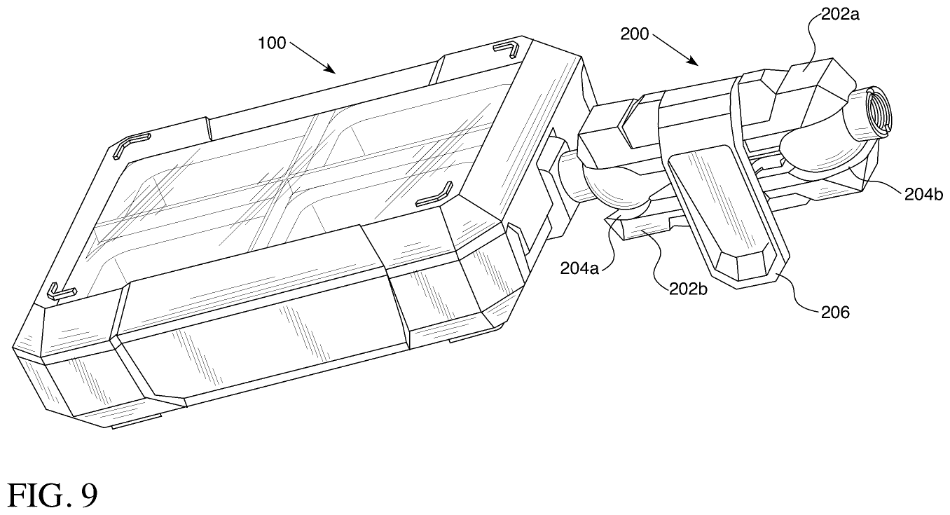

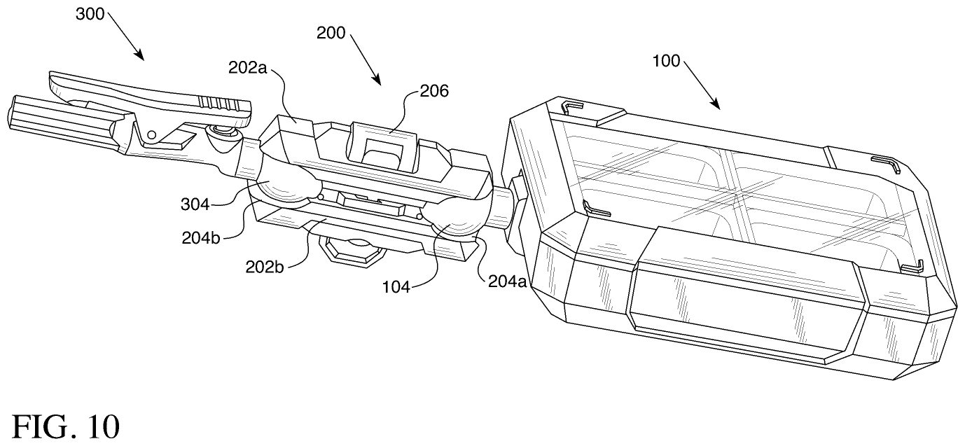

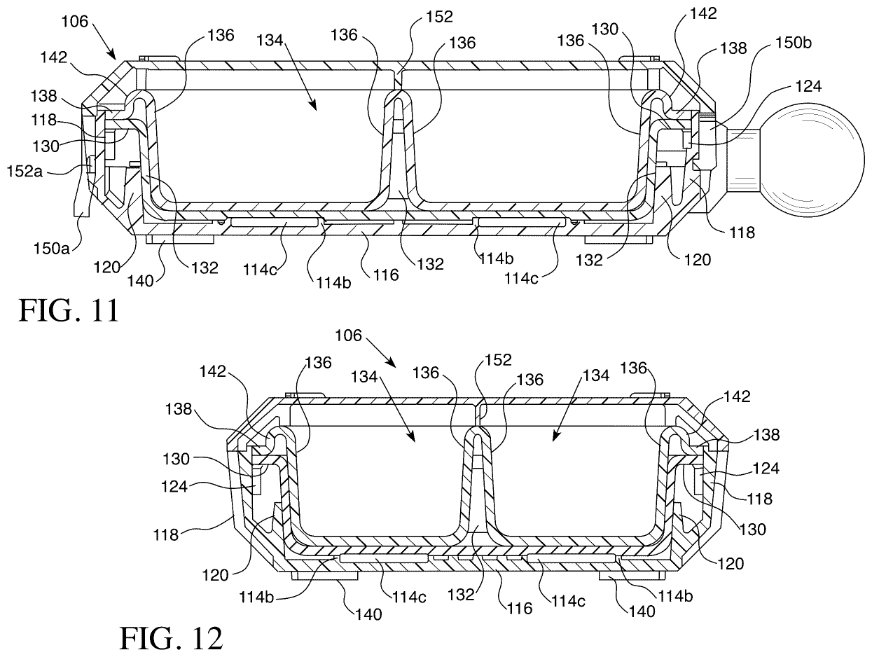

FIG. 1 is a top perspective view of a modular tray system. FIG. 2 is a front view of the modular tray system. FIG. 3 is left side view of the modular tray system; the right side view of the modular tray system is a mirror image. FIG. 4 is a rear view of the modular tray system. FIG. 5 is a top view of the modular tray system. FIG. 6 is a bottom view of the modular tray system. FIG. 7 is a top, perspective exploded view of the modular tray system. FIG. 8 is a bottom, perspective exploded view of the modular tray system. FIG. 9 is a top, perspective view of modular tray system connected to a double ball joint connector. FIG. 10 is a front, perspective view of modular tray system connected to a double ball joint connector that is connected to a connection device. FIG. 11 is a cross-sectional view of the modular tray system connected to taken from line 11-11 in FIG. 5. FIG. 12 is a cross-sectional view of the modular tray system connected to taken from line 12-12 in FIG. 5.

The modular tray system of the present disclosure can readily connect to or engage with a ball joint connector, such as the double ball joint connector illustrated in FIGS. 9-10. In this manner, the tray assembly can transiently retain small components and/or liquids that a user may need while assembling, cleaning, or maintaining a device. The system can include a tray assembly and a ball head joint as well as a cover. As described further herein, the modular tray system can be comprised of materials such as metals, plastics, rubbers, silicones, polycarbonates, glass, and combinations thereof.

In some embodiments, as illustrated herein, the modular tray system 100 can be comprised of a tray assembly 102 and a ball head joint 104 connected to the tray assembly. The modular tray system 100 may also include an attachable cover 106. More specifically, the tray assembly 102 can include a main tray 108 and at least one liner tray 110, 112 placed in an interior portion of the main tray. The interior liner tray layer(s) can take various forms (such as compartmentalized liners) and functions and, further, may cover one or more magnets 114 that are located between the interior liner tray layer(s) and the main tray 108. In such a configuration, the modular tray system 100 may transiently retain small components and/or liquids that a user may need while assembling, cleaning, or maintaining a device.

As illustrated in FIGS. 1 and 5-6, the tray assembly 102 can have a rectangular profile, and can be comprised of several tray/liner layers. Each of these layers may be a comprised of a different, or the same, material. For example, the main tray 108 may be comprised of a plastic; a first liner tray 110 may be comprised of a metal (for example, steel, stainless steel, brass, titanium, or an aluminum alloy) or a composition of metals or, alternatively, a plastic (for example, a polymer); a second liner tray 112 may be comprised of a flexible material such as silicone or rubber; and the cover 106 may be comprised of a similar or different plastic to the main tray. Additionally, some or all of the layers of the tray system can be a continuous, solid material such that those layers can retain liquids and be spill and/or leak-proof.

The main tray 108 of the tray assembly 102, as mentioned above, may have a rectangular profile. However, other shapes (for example, triangles, pentagons, hexagons, octagons, etc.) are considered to sufficiently enable the design, and the tray system is not limited to rectangular profiles. In one embodiment, the main tray can have a base 116 with surrounding vertical walls 118 that protrude perpendicularly to the base. The base 116 can have a planar bottom surface with, optionally, feet 140 protruding from the bottom. The feet can be comprised of the same material as the main tray or they can be a different material. For example, if the main tray is comprised of plastic, the feet may be comprised of a rubber, silicone, or non-slip, high friction coefficient material.

The outer walls 118 of the main tray 108 can be vertical or nearly vertical compared to the base 116. For example, a portion or the entirety of the walls 118 may be perpendicular to the base 116 or they may be at a slight angle. In some cases, the walls 118 may be 90 degrees +/−30 degrees compared to the base 116. For example, as illustrated in FIGS. 2-4, the bottom portion of the outer walls 118 is at an approximate 45-degree angle, whereas the middle and upper portion of the outer walls are closer to perpendicular (i.e., within 15 degrees of a 90-degree angle).

In some embodiments, the outer walls 118 may also include notches or detents 118a into which a hook or catch 124 from the first liner tray 110 can be removably secured to ensure the main tray 108 and first liner tray remain connected during use of the modular tray system 100. As illustrated in FIG. 7, the interior facing portion of at least one of the outer walls 118 can include one or more (for example, two) detents 118a, and at least one edge of the lip 130 of the first liner tray 110 can support one or more (for example, two) corresponding hooks 124. In some cases, each of the outer walls 118 can include two detents 118a and each edge of the lip 130 of the first liner tray 110 can support two hooks 124.

As illustrated in FIGS. 11-12, the hooks 124 in the first liner tray 110 can be parallel to, and spaced apart from, the first liner walls 132 such that a lip 130 of the first liner tray, which can be approximately perpendicular to at least one of the liner walls and the hooks, connects an upper portion of the wall to an upper portion of the hooks. The lip 130 can help to allow the hooks 124 to flex toward and away from the first liner walls 132 so the first liner tray 110 can connect to the main tray 108. In addition to supporting the hooks 124, the lip 130 may include a notch 128 that surrounds a protrusion 126 on the main tray 108. For example, as illustrated in FIG. 7, the protrusion 126 on the main tray 108 is located above the section of the main tray that connects to the ball head joint 104.

Similar to the main tray walls 118, a portion or the entirety of the first liner walls 132 may be perpendicular to the base 116 or they may be at a slight angle. For example, the first liner walls 132 may be 90 degrees +/−30 degrees compared to the base 116 and/or the bottom surface of the first liner. As illustrated in FIGS. 11-12, the first liner walls 132 are close to perpendicular (i.e., within 15 degrees of a 90-degree angle) to the bottom surface of the first liner.

As illustrated in FIGS. 7-8 and 11-12, the first liner tray 110 may sit within the main tray 108. The first liner tray may be permanently affixed to the main tray. In some cases, though, it may be removable. Additionally, while the first liner tray 110 may have walls 132 that are taller than the inner walls 120 of the main tray 108, the first liner walls may be shorter than the outer walls 118 of the main tray such that the top of the first liner walls do not rise above the plane of the top of the main tray walls. Further, while the illustrated first liner tray is shown having one compartment, it is envisioned that the first liner tray may have multiple compartments. The first liner tray may be a continuous, solid material even when it is comprised of multiple compartments. As illustrated, the first liner tray 110 has one compartment, nests inside the main tray 108, and receives the second liner tray 112.

In addition to the outer walls 118, the main tray 108 can have a set of interior walls 120. The interior walls 120 may be offset from the outer walls 118 by spacers 122, which can act to divide and support the two sets of walls. In some embodiments, the dimensions of the interior walls 120 closely align with or match the dimensions of the first liner walls 132 such that the first liner tray 110 sits adjacent to, and in some cases touching, the interior walls of the main tray 108, as illustrated in the cross-sectional illustrations of FIGS. 11-12. Additionally, the width of the spacers 122 may align closely with the width of the lip 130 of the first liner tray 110. Therefore, as illustrated in FIGS. 11-12, the lip 130 may span from the interior walls 120 of the main tray 108 to the interior portion of the outer walls 118 of the main tray. These dimensions allow the first liner tray 110 to closely nest in the main tray 108.

In addition to supporting and housing the first liner tray 110, the main tray 108 may also house one or more magnets 114c in a magnet housing 114, as illustrated in FIGS. 7-8 and 11-12, such that the tray assembly 102 can have the ability to magnetically retain metal components with the tray(s). In some embodiments, the magnet housing 114 can have raised bumpers 114b that are approximately the same shape and size (for example, diameter) as magnet(s) 114c, such that the magnet housings 114 are shaped to accept and retain the magnet(s) in a fixed position. For example, if the magnets 114c are circular, the raised bumpers 114b may also be circular and can have an interior 114a that is sized to accept the circular magnets. As illustrated in FIGS. 11-12, the interior area 114a of the magnet housing 114 may be recessed and the bumpers 114b slightly elevated relative to the interior bottom surface 116 of the main tray 108.

The magnet(s) 114c may be sandwiched between the main tray 108 and the first liner tray 110. The first liner tray 110 may be thin enough to allow the magnetic force from the magnet(s) 114c to penetrate through from one side of the liner base to the opposite side of the liner base. In some cases, the first liner tray 110 may distribute the forces of each magnet 114c such that the area of the first liner tray that is magnetic is greater than the sum area of the magnets.

In some embodiments, the magnet housing 114 may be comprised of one or more individual housings. For example, as illustrated in FIGS. 7-8, the tray assembly 102 may include a plurality of magnet(s) 114c that are spaces throughout the main tray 108. In some cases where a second liner tray 112 having multiple compartments 134 is present, the number of magnets 114c may align with the total number of compartments. For example, as illustrated in FIG. 7, in embodiments have four compartments 134 in the second liner tray 112, there may be four magnets 114c, one located underneath each compartment. This is not required, though, and other embodiments are considered where there may be one or more compartments in a liner tray that are not associated with any magnet(s), or where there are one or more compartments in a liner tray that each have multiple magnets, or where there is one magnet that may function to make more than one compartment magnetically attractive, or where there are portions of a compartment or a liner tray that are magnetically attractive and portions of a compartment or liner tray that are not magnetically attractive, wherein both portions are part of the same compartment or liner tray.

In addition to housing the one or more magnets 114c, the main tray 108 may have a connection to the ball head joint 104. The ball head joint 104 can have a stem 146 and a ball head 144. The ball head 144 may, but is not limited to, various sizes such as ¼ inch, ½ inch, 1 inch, 2 inches, etc. More specifically, the ball head 144 may range in size from ¼ inch up to 4 inches. The cross-section of the stem 146 may be circular, oval, or angled (for example, square, hexagonal, etc.). As illustrated in FIGS. 1, 3, and 5-7, the stem 146 may be relatively short such that it has a length shorter than a diameter/length of the ball head 144. The longitudinal axis of the stem 146 may be parallel to a bottom plane of the main tray 108. In some embodiments, as shown herein, the stem 146 can connect to an outer wall 118 of the main tray 108. However, the stem 146 could alternatively connect to the bottom planar surface of the main tray 108. Further, while the stem 146 is illustrated as connecting only to the main tray 108, it could penetrate further into the tray assembly 102 and connect with one or more of the liner trays 110, 112 as well. As illustrated herein, in some cases, the ball head joint 104 may be threadedly engaged with the main tray 108. In other cases, the ball head joint 104 may be more permanently affixed to the main tray 108.

In some cases, the ball head joint 104 may be fixedly connected to the tray assembly 102 such that it cannot rotate, swivel, bend, flex, or otherwise move relative to the tray assembly unless it is completely removed. Additionally, each component of the ball head joint may be fixed in place relative to each other component. Alternatively, it is possible that the stem 146 may be positionable at a non-parallel angle to the ball head joint 104. For example, the stem 146 may have one or more joints or may have a jointed connection to the tray assembly 102. In another example, the stem 146 may be bendable into a non-parallel position with the tray assembly 102. In yet another example, the connection of the ball head 144 to the stem 146 may be maneuverable or transient, such that it allows for non-parallel positioning between those two elements, thereby allowing the tray assembly 102 to be non-parallel to one or more parts of the ball head joint 104.

The benefit of the ball head joint 104 is that the modular tray system 100 can connect, at the point of the ball head 144, to a double ball receiver assembly 200. As illustrated in FIGS. 9-10, the assembly 200 can be a double ball receiver device that includes two housing halves 202a-b, a female receiver 204a on a first end, a female receiver 204b on a second end, and a locking mechanism 206.

For example, the ball head joint 104 can fit within a female receiver 204a of a double ball receiver assembly 200, and a second ball head joint 304 can connect opposite the ball head joint in a second female receiver 204b that is opposite the first female receiver. A locking mechanism 206 such as a cam lock, can clamp the two halves 202a-b of the assembly 200 together such that both female receivers 204a-b can securely clamp onto ball head joints 104, 304. When the locking mechanism 206 is released, both ball head joints 104, 304 may be removable from the assembly 200. As illustrated in FIGS. 9-10, the locking mechanism 206 may be located in a center of the assembly 200 in order to enable the mechanism to simultaneously clamp both halves 202a-b together and prevent movement from either ball head joint 104, 304. In some cases, the ball head joint 304 may connect on one end to the receiver assembly 200 and on the other end to a gooseneck. Attachment of the modular tray system 100 to an extension portion that can be bent, manipulated, and/or positioned into several positions where it can retain its position indefinitely (for example, using a flexible gooseneck tube) enables the tray assembly 102 to be suspended in space and, therefore, easier for a user to access while working on a project.

In some embodiments, the assembly 200 may unilaterally release a ball head joint. Therefore, in those cases, the receptacle may include two locking mechanisms or a locking mechanism having separate locking components. This enables a user to keep one ball head joint fixed in place while releasing, adjusting, and/or maneuvering the other ball head joint before locking it in place. For example, if the assembly 200 has two locking mechanisms, each mechanism may control one of the female receivers 204a-b. Alternatively, one locking mechanism may lock one female receiver, whereas the other locking mechanism may lock both female receivers 204a-b. In an example of one locking mechanism with separate locking components, the mechanism may take place in steps, wherein a first step locks one side and then a second step locks the other, or both, sides.

And in some cases, assembly 200 may be permanently attached to one ball head joint such that the locking mechanism may release the pressure on the ball head joint, but it won't release it completely from the assembly. This would enable the assembly 200 to be moveable relative to, but permanently attached to, one ball head joint while transiently attached to the other ball head joint.

In one embodiment, the assembly 200 may connect in different ways to each of ball head joints 104 and 304. For example, ball head joint 304 may remain connected to assembly 200 regardless of whether or not the locking mechanism 206 is engaged or not, whereas ball head joint 104 can be easily removed when the locking mechanism is not engaged. In some embodiments, the inverse may be true. For example, when the assembly 200 is flipped around and ball head joint 104 is connected to second female receiver 204b while ball head joint 304 is connected to first female receiver 204a, it can be possible for ball head joint 104 to reman connected to the assembly regardless of whether or not the locking mechanism 206 is engaged or not, whereas ball head joint 304 can be easily removed when the locking mechanism is not engaged.

As shown herein, the second ball head joint 304 can be connected to an accessory clamp 300. This accessory clamp 300 is described and shown in detail in U.S. Patent D1,080,371, U.S. application Ser. Nos 18/536,476 and Ser. No. 29/917,556, and C.N. Patents 309090686S and 309483706S and is hereby incorporated herein by reference.

In some embodiments, instead of the main tray 108 having a connection to the ball head joint 104, the main tray may instead connect directly to a different type of connection apparatus. For example, the main tray 108 may connect directly to an extension portion such as the one described above. More specifically, the extension portion can connect between the main tray 108 and the accessory clamp 300, and the accessory clamp can exclude the ball head joint 304. Additionally, the extension portion can be a component capable of being bent, manipulated, and/or positioned into several positions where it can retain its position indefinitely and can enable the tray assembly 102 to be suspended in space.

As mentioned above, in addition to the first liner tray 110, the tray assembly 102 may include a second liner tray 112. The second liner tray 112 may be the same material as the first liner tray 110 or, more commonly, a different material. For example, the second liner tray 112 may be comprised of silicone. In some cases, as mentioned above and illustrated in FIGS. 7-8, the second liner tray 112 may have a plurality of compartments 134 (two compartments, three compartments, four compartments, etc.). The compartments 134 may be identical in size and shape, as shown herein, or they may vary. For example, FIG. 5 shows the second liner tray 112 can have four identically sized and shaped compartments 134 that are defined by walls 136 that divide the length of the liner in half and the width of the liner in half. In cases where the tray assembly 102 is rectangular in shape, the compartments 134 may, therefore, also be rectangular in shape. However, identically shaped compartments are not required for enablement and, in some cases, the compartments may be of various shapes, lengths, widths, and/or depths. Further, since the modular tray system 100 allows for the second liner tray 112 to be removable, it is envisioned that various trays can be swapped in and out of the tray assembly depending on the needs of the user. In some cases, the user may need one large compartment whereas, in other cases, the user may need a plurality of compartments that are either similar sizes or a variation of sizes. As illustrated, the second liner tray 112 may be a continuous, solid material even when comprised of multiple compartments 134.

In some embodiments, the second liner tray 112 may be made of a material, or of a thickness, that enables one or more magnets to continue retaining a magnetic force on components that are placed inside the second liner. As mentioned above, the tray assembly 102 may include at least one magnet 114c for each compartment 134. Therefore, as illustrated in FIGS. 11-12, each compartment 134 may have a magnet 114c centered on the bottom surface of the compartment. The second liner tray 112 may be removable to enable for easy cleaning or removal of a liner having a plurality of compartments.

As illustrated in FIGS. 1-12, the upper end of the walls 136 of the second liner tray 112 may be located above the upper end of the outer walls 118, the inner walls 120, and/or the first liner walls 124. As such, when the second liner tray 112 is nested within the first liner tray 110, or if the second liner tray is placed directly in the main tray 108, the top of the second liner walls 136 may rise above the plane of the top of the main tray outer walls 118.

Similarly to the first liner tray 110, the top of the second liner tray 112 may have a lip 138 that can be approximately perpendicular to at the liner walls 136. The lip 138 may be present along every edge of the second liner tray 112 and, therefore, can cover the lip 130 of the first liner tray 110. Unlike the lip 130 of the first liner tray 110, however, the lip 138 of the second liner tray 112 may be spaced apart from the liner walls 136. For example, as illustrated in FIGS. 11-12, the liner walls 136 may continue past the height of the first liner tray 110 and/or the main tray 108 such that there is a gap between the two planes of the tops of main tray/first liner walls 120/132 and second liner walls 136. However, the lip 138 of the second liner tray 112 can rest on top of the lip 130 of the first liner tray 110. Therefore, a connection wall 142 may be present to connect the top of the liner walls 136 to the lip 138. The connection wall 142 may be approximately parallel (within 5-10 degrees) to the liner walls 136, as illustrated in FIGS. 11-12.

As illustrated in FIGS. 1-4 and 7-12, the main tray 108 and the cover 106 can sandwich the liner layer trays 110, 112 between them. Therefore, while the cover 106 may, more generally, connect to the tray assembly 102, it may more specifically connect directly to the main tray 108. In some embodiments, that connection is a snap fit. For example, the cover 106 may have a locking mechanism that is positioned exterior to the exterior wall 118 of the tray assembly 102 and hooks around a ledge on the tray assembly, thereby securing the cover to the tray assembly. However, a snap fit is not required and other connection types that are known in the art, such as an interference fit, may be utilized.

In some embodiments, the locking mechanism 150a may be a vertical living hinge with a cutout into which a ledge 152a fits, as illustrated in FIG. 8. In other cases, the locking mechanism 150b may be comprised of a vertical living hinge with a hook on the end that hooks around a ledge 152b, as illustrated in FIG. 7. In some cases, the locking mechanism 150a may be one continuous piece having a vertical living hinge with a cutout that corresponds to a ledge on the main tray 108, as illustrated in FIG. 8. In other cases, the locking mechanism 150b may be comprised of more than one connection component (i.e., the locking mechanism may be split into multiple components). For example, as illustrated in FIG. 7, the connection of the cover 106 to the tray assembly 102 on the side of the ball head joint 104 may be comprised of a split locking mechanism 150a, such that one portion of the locking mechanism is to a first side of the ball head joint and the other portion is to the other side of the ball head joint.

In one example, the cover 106 may have locking mechanisms 150a/b on opposing sides such that it locks onto the tray assembly 102 at two positions. One of those locking mechanisms 150b may be near or adjacent to the ball head joint 104, as illustrated in FIG. 7, and the other of those locking mechanisms 150a may be on an opposing side, as illustrated in FIG. 8. However, this configuration is not required, and the locking mechanism may take place on the sides of the tray assembly that are adjacent to the side having the ball head joint. Additionally, the cover may have more than two locking mechanisms (for example, locking mechanisms on three sides, on four sides, or on more than four sides if the tray assembly has more than four sides).

When the cover 106 is placed on the tray assembly 102, the lower edges of the cover can sit on the ledge 148 of the main tray 108. Therefore, the main tray 108 and the cover 106 may have minimal overlap. For example, as illustrated in FIGS. 2-4, the lower edge of the cover 106 effectively meets the upper edge of the main tray 108. To ensure the two pieces stay together, the lower edge of the cover 106 can nest in or on the ledge 148 of the main tray 108, and the cover can include the locking mechanism described above. As such, while the majority of the cover 106 sits above the main tray 108, a portion of it (i.e., the locking mechanism) may overlap the external walls 118 of the main tray and latch onto the main tray.

As illustrated clearest in FIGS. 5 and 7, the cover 106 may be solid and transparent. This allows a user to see what is being stored in the modular tray system 100 when the cover 106 is on to the tray assembly 102. Additionally, to accommodate liners having multiple compartments, the cover may have ridges corresponding to the liner walls of the liner with compartments. For example, the second liner tray 112 in the current disclosure has four compartments 134 defined by two intersecting walls. Therefore, to ensure that any items/liquids do not spill into adjacent compartments when the cover 106 is locked onto the tray assembly 102, the cover may include two intersecting ridges 154 that correspond to, and make physical contact with, the two intersecting walls 136 when the cover is locked onto the tray, as illustrated in FIGS. 11-12. This creates airtight seals between compartments 134 in the second liner tray 112.

Persons of ordinary skill in arts relevant to this disclosure and subject matter hereof will recognize that embodiments may comprise fewer features than illustrated in any individual embodiment described by example or otherwise contemplated herein. Embodiments described herein are not meant to be an exhaustive presentation of ways in which various features may be combined and/or arranged. Accordingly, the embodiments are not mutually exclusive combinations of features; rather, embodiments can comprise a combination of different individual features selected from different individual embodiments, as understood by persons of ordinary skill in the relevant arts.

Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

What is claimed is:

1. A modular tray system comprising:
a tray assembly having
a main tray, and
at least one liner tray nested in an interior of the main tray; and
a ball head joint having a ball head and a stem, wherein the stem connects to the tray assembly.

2. The modular tray system of claim 1, further comprising at least one magnet.

3. The modular tray system of claim 2, wherein
the at least one magnet is an array of magnets, and
the array of magnets is located between the main tray and the at least one liner tray.

4. The modular tray system of claim 3, wherein
the main tray has a rectangular profile,
the main tray has a solid base and four solid walls, and
the array of magnets includes four magnets, one near each corner.

5. The modular tray system of claim 3, wherein
the at least one liner tray has a plurality of compartments, and
at least one magnet from the array of magnets is located underneath each of the plurality of compartments.

6. The modular tray system of claim 1, the at least one liner tray comprising a first liner tray and a second liner tray.

7. The modular tray system of claim 6, wherein
the second liner tray has a plurality of compartments, and
the modular tray system further comprises a cover having a plurality of compartments that correspond to the compartments of the second liner tray.

8. The modular tray system of claim 7, wherein
the cover is securely attachable to the tray assembly, and
the second liner and the cover create an airtight seal.

9. The modular tray system of claim 6, wherein the second liner tray is removable.

10. The modular tray system of claim 6, wherein the second liner tray is comprised of silicone.

11. The modular tray system of claim 6, further comprising an array of magnets evenly distributed between the main tray and the first liner tray.

12. The modular tray system of claim 11, wherein
the first liner tray is permanently affixed to the main tray,
the second liner tray is a removable, flexible liner tray, and
the stem of the ball head joint is affixed to the main tray.

13. The modular tray system of claim 1, further comprising a cover.

14. The modular tray system of claim 13, wherein the cover and the tray assembly create an airtight seal.

15. The modular tray system of claim 13, wherein the cover is transiently affixed to the tray assembly.

16. The modular tray system of claim 15, wherein the cover has a snap fit engagement with the main tray.

17. The modular tray system of claim 1, wherein the ball head joint connects to a side of the tray assembly such that a longitudinal axis of the stem is parallel to a bottom plane of the main tray.

18. The modular tray system of claim 1, wherein the ball head joint is threadedly engaged with the tray assembly.

19. The modular tray system of claim 1, wherein the at least one liner tray is comprised of a continuous, solid material.

20. The modular tray system of claim 1 in combination with a double ball receiver assembly, wherein
the ball head of ball head joint is receivable in a first end of the double ball receiver assembly,
a second ball head is receivable in a second end of the double ball receiver assembly,
the double ball receiver assembly includes a locking mechanism to secure the ball head and the second ball head to the double ball receiver assembly,
the locking mechanism has an engaged position and a disengaged position, and
the second ball head is retained by the locking mechanism in the engaged and the disengaged position.

21. A modular tray system comprising:
a tray assembly having
a main tray,
a first liner tray nested in an interior of the main tray, and
a second liner tray nested in an interior of the first liner tray;
at least one magnet located between the main tray and the first liner tray; and
a connection apparatus connected to the tray assembly.

22. The modular tray system of claim 21, wherein the connection apparatus enables the tray assembly to be suspended in space.

23. The modular tray system of claim 22, wherein the connection apparatus has a gooseneck, and the tray assembly connects to the gooseneck.
